(19) United States
(12) Patent Application Publication
(10) Pub. No.: US 2025/0044222 A1
(43) Pub. Date: Feb. 6, 2025

(54) IMAGE MEASUREMENT DEVICE AND METHOD THEREOF

(71) Applicant: SAMSUNG ELECTRONICS CO., LTD, SUWON-SI (KR)

(72) Inventors: Seungwoo LEE, SUWON-SI (KR); Jinseob KIM, SUWON-SI (KR); Jinyong KIM, SUWON-SI (KR); Taejoong KIM, SUWON-SI (KR); Jinwoo AHN, SUWON-SI (KR); Jaehwang JUNG, SUWON-SI (KR); Taeyong JO, SUWON-SI (KR); Garam CHOI, SUWON-SI (KR)

(21) Appl. No.: 18/767,486

(22) Filed: Jul. 9, 2024

(30) Foreign Application Priority Data
Aug. 4, 2023 (KR) 10-2023-0102283

(51) Int. Cl. G01N 21/31; G06T 7/11

(52) U.S. Cl. CPC G01N 21/31; G06T 7/11; G06T 2207/20021; G06T 2207/20056

(57) ABSTRACT

An image measurement device includes an optical system that transmits light output to an image detection unit, the image detection unit configured to detect the light and generate an image, and an image processing unit that extracts spectral data from the image, wherein the image processing unit generates a profile according to an amount of light for each of a plurality of pixels based on the image, and performs Fourier transform on the profile.

### CROSS-REFERENCE TO RELATED APPLICATION

A claim of priority under 35 U.S.C. § 119 is made to Korean Patent Application No. 10-2023-0102283, filed on Aug. 4, 2023, in the Korean Intellectual Property Office, the disclosure of which is incorporated by reference herein in its entirety.

### BACKGROUND

The inventive concept relates to a spectrometer, a polarimeter, and a spectroscopic measurement method.

In current semiconductor manufacturing processes, design rules are continuously shrinking, and as a result, the size of device patterns is also decreasing. This presents challenges to current measurement devices that are used measuring patterns and other properties on a wafer or mask. That is, resolution issues relating to wavelengths and decreased measurement accuracy may occur due to the reduced pattern size.

### SUMMARY

According to an aspect of the inventive concept, there is provided an image measurement device including an optical system that transmits light to an image detection unit, the image detection unit configured to detect the light and generate an image, and an image processing unit that extracts spectral data from the image, wherein the image processing unit generates a profile according to an amount of light for each of a plurality of pixels based on the image.

According to another aspect of the inventive concept, there is provided an image measurement device including an optical system that transmits light to an image detection unit, the image detection unit configured to detect the light and generate an image, and an image processing unit that extracts spectral data from the image, wherein the optical system includes a relay lens including at least one lens and a self-interference structure configured to self-interfere the light, and the self-interference structure includes a polarizer that polarizes the light and a retarder that delays the phase of the light.

According to another aspect of the inventive concept, there is provided an image measurement device including an optical system that transmits light to an image detection unit, the image detection unit configured to detect the light and generate an image, and an image processing unit that extracts spectral data from the image, wherein the optical system includes a relay lens including at least one lens and a self-interference structure configured to self-interfere the light, and the self-interference structure includes a polarizer that polarizes the light and a retarder that delays the phase of the light, and the image processing unit generates a profile according to an amount of light for each of a plurality of pixels based on the image and performs Fourier transform on the profile, the image processing unit separates the profile into a high-frequency region and a low-frequency region by performing Fourier transform on the profile, and divides the high-frequency region into a plurality of sections through windowing, and extracts frequency components by applying preset weights to the plurality of sections, and extracts spectral data from the frequency components by using zoom Fast Fourier transform.

### BRIEF DESCRIPTION OF THE DRAWINGS

Embodiments will be more clearly understood from the following detailed description taken in conjunction with the accompanying drawings in which:

FIG. 1 is a structural diagram schematically illustrating an image measurement device for measuring a spectral signal, according to an embodiment;

FIG. 2 is a perspective view showing a portion of the image measurement device according to FIG. 1;

FIG. 3 is a structural diagram schematically illustrating an image measurement device for measuring spectral signals and polarization signals, according to an embodiment;

FIG. 4 is a flowchart of an image detection method according to an embodiment;

FIG. 5 illustrates an image obtained by an image detector according to an embodiment;

FIG. 6 is a graph showing a profile according to the amount of light for a plurality of pixels, according to an embodiment;

FIG. 7 is a graph showing data obtained by performing Fourier transform on a profile, according to an embodiment;

FIGS. 8 and 9 are graphs showing spectral data generated using Zoom fast Fourier Transform according to an embodiment;

FIG. 10 illustrates an image obtained by an image detector, according to an embodiment;

FIGS. 11A and 11B are graphs showing a profile according to the amount of light for each of a plurality of pixels, according to an embodiment;

FIG. 12 is an image showing data obtained by performing Fourier transform on a profile, according to an embodiment; and

FIG. 13 is a graph showing spectral data generated using Zoom fast Fourier Transform, according to an embodiment.

### DETAILED DESCRIPTION OF THE EMBODIMENTS

Hereinafter, embodiments will be described in detail with reference to the accompanying drawings. The same reference numerals are used for the same components in the drawings, and repeated descriptions thereof are omitted.

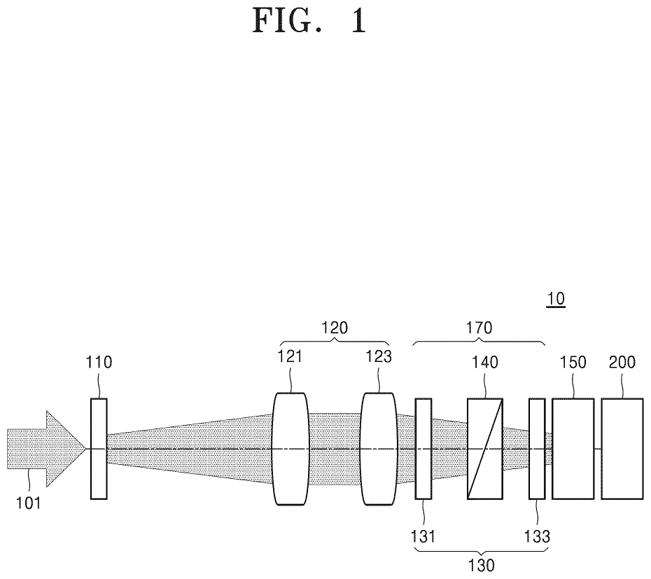

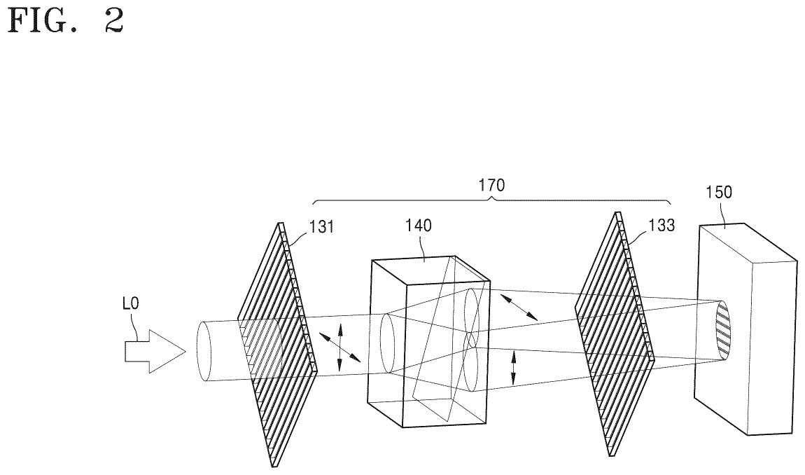

FIG. 1 is a structural diagram schematically illustrating an image measurement device for measuring a spectral signal, according to an embodiment. FIG. 2 is a perspective view showing a portion of the image measurement device of FIG. 1.

Referring to FIGS. 1 and 2, a high-resolution spectrometer 10 may include a light source 101, an optical system (110, 120 and 170 in the example of FIG. 1), an image detection unit 150, and an image processing unit 200.

The high-resolution spectrometer 10 may measure or monitor properties of a semiconductor device using images. For example, the high-resolution spectrometer 10 may measure or monitor properties of a semiconductor device by using ellipsometry, reflectometry, holography, and/or interferometry.

The optical system may transmit light incident from the light source 101, by using a plurality of optical elements. In the high-resolution spectrometer 10 according to the present embodiment, the optical system may include a light diffusion plate 110, a relay lens 120, and a self-interference structure 170.

The self-interference structure 170 may polarize light. The self-interference structure 170 may also self-interfere the light by delaying the phase of the light. The self-interference structure 170 may include a polarizer 130 and a retarder 140. There may be a plurality of polarizers 130 and/or retarders 140. For example, a polarizer 130 may include a first polarizer 131 and a second polarizer 133. Additionally, in another embodiment to be described later, a retarder 140 may include a first retarder and a second retarder. The retarder 140 may include any one of a Nomarski prism, a Wollaston prism, and a beam displacer.

Referring to FIGS. 1 and 2, in the self-interference structure 170, the first polarizer 131 and the second polarizer 133 of the polarizer 130 may be arranged between the relay lens 120 and the image detection unit 150. Additionally, the retarder 140 of the self-interference structure 170 may be arranged between the first polarizer 131 and the second polarizer 133. Additionally, the first polarizer 131 may be disposed between the relay lens 120 and the retarder 140. Additionally, the second polarizer 133 may be disposed between the retarder 140 and the image detection unit 150. In embodiments, the first polarizer 131 may polarize light into S-polarized light and P-polarized light. The retarder 140 may delay the phases of S-polarized light and P-polarized light, respectively.

Still referring to FIGS. 1 and 2, the high-resolution spectrometer 10 according to the inventive concept may include the light diffusion plate 110, the relay lens 120, and the self-interference structure 170, which are arranged as described above, and thus, an image of light having a light amount to which Equation 1 and Equation 2 below are applied may be obtained.

$${I}_{out} ( k , x ) = [ 1000 ] \frac{1}{2} [ \begin{matrix}1 & 1 & 0 & 0 \\ 1 & 1 & 0 & 0 \\ 0 & 0 & 0 & 0 \\ 0 & 0 & 0 & 0\end{matrix} ] [ \begin{matrix}1 & 0 & 0 & 0 \\ 0 & cos ( ϕ ) & 0 & - sin ( ϕ ) \\ 0 & 0 & 1 & 0 \\ 0 & sin ( ϕ ) & 0 & cos ( ϕ )\end{matrix} ] \frac{1}{2} [ \begin{matrix}1 & 1 & 0 & 0 \\ 1 & 1 & 0 & 0 \\ 0 & 0 & 0 & 0 \\ 0 & 0 & 0 & 0\end{matrix} ] {S}_{in} ( k ) \qquad Equation 1$$

Here, I_{out(k, x)} denotes the amount of light for each wave number k and each location x, where the wave number is

$$k = \frac{2 π}{λ} ,$$

and phase delay

$$ϕ = \frac{2 π}{λ} x = kx$$

(ϕ is the phase delay of the retarder 140 with respect to the x-axis),

$${S}_{in} ( k ) = [ \begin{matrix}{S}_{0} ( k ) \\ 0 \\ 0 \\ 0\end{matrix} ]$$

denotes incident light, F{ } denotes Fourier transform, and S₀(k) may be constant along the x-axis.

Sᵢₙ(k) represents light that is incident from a light source and passes through the light diffusion plate 110 and becomes unpolarized, and is expressed in the form of a Stokes vector. It is assumed that, when the light passes through the self-interference structure 170 and is focused on the image detection unit 150, among the components constituting the self-interference structure 170, the first polarizer 131 is 0 degrees, the retarder 140 is 45 degrees, and the second polarizer 133 is 0 degrees. Also, it is assumed that the retarder 140 causes a phase delay that changes in space in an x-direction with respect to the light.

Regarding light focused on the image detection unit 150, the amount of light integrated with respect to the wave number is measured, which thus may be expressed as Equation 2 below.

$${I}_{out , measure} ( x ) = {\int }_{- ∞}^{∞} {I}_{out} ( k , x ) dk = \frac{1}{4} {\int }_{- ∞}^{∞} {S}_{0} ( k ) dk + \frac{1}{4} {\int }_{- ∞}^{∞} {S}_{0} ( k ) cos ( kx ) dk = \frac{1}{4} {\int }_{- ∞}^{∞} {S}_{0} ( k ) dk + \frac{1}{8} {\int }_{- ∞}^{∞} {S}_{0} ( k ) {e}^{jkx} dk + \frac{1}{8} {\int }_{- ∞}^{∞} {S}_{0} ( k ) {e}^{- jkx} dk = \frac{1}{4} {DC}_{{S}_{0}} + \frac{1}{8} \{ {S}_{0} ( k ) \} + \frac{1}{8} {\{ {S}_{0} ( k ) \}}^{*} \qquad Equation 2$$

Here, I_{out,measure}(x) represents the amount of light integrated with respect to the wave number, I_{out(k, x)} represents the amount of light for each wave number k and each location x, the wave number

$$k = \frac{2 π}{λ} ,$$

phase delay

$$ϕ = \frac{2 π}{λ} x = kx$$

(ϕ is the phase delay of the retarder 140 with respect to the x-axis),

$${S}_{in} ( k ) = [ \begin{matrix}{S}_{0} ( k ) \\ 0 \\ 0 \\ 0\end{matrix} ] ,$$

F{ } represents Fourier transform, and S₀(k) may be constant along the x-axis.

Equation 1 and Equation 2 indicate that the amount of light I_{out,measure}(x) of light imaged by the high-resolution spectrometer 10 having the self-interference structure 170 according to the inventive concept described above and the spectrum S₀(k) of the light are in a Fourier transform relationship with each other. Therefore, if I_{out,measure}(x) is Fourier transformed with respect to an x component, the spectrum S₀(k) in a wave number component may be measured.

The light diffusion plate 110 may uniformly diffuse the light incident from the light source 101. The light diffusion plate 110 may be arranged in front of the light source 101. The light diffusion plate 110 may diffuse the light incident from the light source 101 toward the relay lens 120. In other words, the light diffusion plate 110 may uniformly emit non-uniform light from the light source 101 to the front and change the light incident from the light source 101 into an unpolarized state.

In embodiments, the relay lens 120 may include two lenses, and light incident on the relay lens 120 may be incident on one of the polarizer 130 and the retarder 140. Light diffused through the light diffusion plate 110 may be incident on the relay lens 120. The relay lens 120 may condense the light that has passed through the light diffusion plate 110 and form an image, and then make the light be incident on the polarizer 130. The light incident on the polarizer 130 may be incident on the retarder 140.

In embodiments, the relay lens 120 may include a first relay lens and a second relay lens. Here, the first relay lens may be disposed between the light diffusion plate 110 and the polarizer 130. Additionally, the second relay lens may be disposed between the polarizer 130 and a photodetector.

The relay lens 120 may transmit light passing through the polarizer 130 to the image detection unit 150. In embodiments, the relay lens 120 may include a pair of two lenses. Additionally, according to an embodiment, the relay lens 120 may further include at least one optical element.

The image detection unit 150 may detect light as an image. That is, the image detection unit 150 may detect the light and generate the same as an image. Additionally, in embodiments, the image detection unit 150 may include one of a complementary metal-oxide semiconductor (CMOS) and a charged coupled device (CCD). The image detection unit 150 may transmit the image generated from the light, to the image processing unit 200. The image detection unit 150 may generate an image having various exposure times, based on light reflected from a measurement object. Additionally, the image detection unit 150 may generate an image having various wavelengths, based on light reflected from the measurement object.

The image processing unit 200 may generate spectral data through a series of processing processes on the image obtained from the image detection unit 150. The image processing unit 200 may be physically implemented by one or more microprocessors and memory, programmed using software and/or firmware (e.g., microcode) to perform the various functions and execute the processes discussed herein. Alternatively, all or part of the image processing unit 200 may be implemented by dedicated hardware, or as a combination of dedicated hardware to perform some functions and a processor (e.g., one or more programmed microprocessors and associated circuitry) to perform other functions. According to embodiments, the image processing unit 200 may generate a profile according to the amount of light for each of a plurality of pixels, based on the image. Additionally, the image processing unit 200 may perform Fourier transform on the profile to separate the profile into a high-frequency region and a low-frequency region.

Additionally, the image processing unit 200 may extract spectral data by using windowing and zoom fast Fourier transform on the high-frequency region or the low-frequency region. Specifically, the image processing unit 200 may divide the high-frequency region into a plurality of sections by windowing the high-frequency region. The image processing unit 200 may extract frequency components by applying preset weights to the plurality of sections. Additionally, in an embodiment, the image processing unit 200 may extract spectral data from the frequency components by using zoom fast Fourier transform.

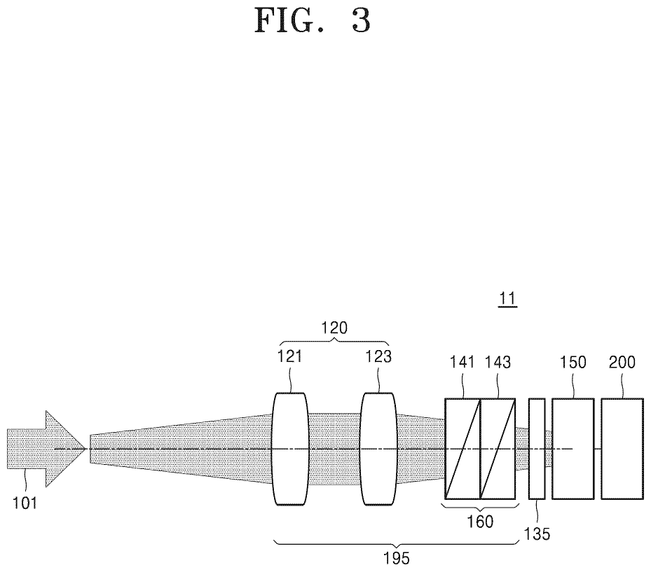

FIG. 3 is a structural diagram schematically illustrating an image measurement device for measuring spectral signals and polarization signals, according to an embodiment. The description of FIG. 3 will be provided with reference to FIGS. 1 and 2, but details already described with respect to FIGS. 1 and 2 may be only briefly described or omitted below to avoid redundancy. In addition, below, since a polarimeter 11 represents an embodiment different from the embodiment of FIGS. 1 and 2, the description will primarily focus on the differences between the two embodiments.

Referring to FIG. 3, the polarimeter 11 may include a self-interference structure 195. The self-interference structure 195 may include a relay lens 120, a plurality of retarders 160, and a polarizer 135. Here, the plurality of retarders 160 may include a first retarder 141 and a second retarder 143. Also, here, the polarimeter 11 may not include the light diffusion plate 110 of FIGS. 1 and 2. Accordingly, light incident from the light source 101 to the relay lens 120 may be polarized light.

Here, the polarizer 135 may be disposed between the relay lens 120 and the image detection unit 150. Additionally, the first retarder 141 and the second retarder 143 corresponding to the plurality of retarders 160 may be in contact with each other. Additionally, the first retarder 141 and the second retarder 143 may be disposed between the relay lens 120 and the polarizer 135.

As the polarimeter 11 according to the present embodiment includes the self-interference structure 195, and the self-interference structure 195 includes the relay lens 120, the plurality of retarders 160, and the polarizer 135, which are arranged as described above, an image of light having a light amount to which Equation 3, Equation 4, and Equation 5 below are applied may be obtained.

First, since the polarimeter 11 does not include a light diffusion plate, the light incident on the relay lens 120 may be expressed as Equation 3 below.

$${S}_{in} ( k ) = [ \begin{matrix}{S}_{0} ( k ) \\ {S}_{1} ( k ) \\ {S}_{2} ( k ) \\ {S}_{3} ( k )\end{matrix} ] , {ϕ}_{x} = \frac{2 π}{λ} x = kx , {ϕ}_{y} = \frac{2 π}{λ} y = ky \qquad Equation 3$$

In Equation 3, Sᵢₙ(k) represents the incident light incident on the relay lens 120, ϕₓ represents the phase delay about the x-axis, and ϕ_{y} represents the phase delay about the y-axis.

Equation 4 below represents the amount of light for each wave number, each location x, and for each location y, the light being formed as an image on the image detection unit 150 after passing through the self-interference structure 195.

$${I}_{out} ( k , x , y ) = [ 1000 ] \frac{1}{2} [ \begin{matrix}1 & 1 & 0 & 0 \\ 1 & 1 & 0 & 0 \\ 0 & 0 & 0 & 0 \\ 0 & 0 & 0 & 0\end{matrix} ] [ \begin{matrix}1 & 0 & 0 & 0 \\ 0 & cos ( {ϕ}_{y} ) & 0 & - sin ( {ϕ}_{y} ) \\ 0 & 0 & 1 & 0 \\ 0 & sin ( {ϕ}_{y} ) & 0 & cos ( {ϕ}_{y} )\end{matrix} ] \frac{1}{2} [ \begin{matrix}1 & 0 & 0 & 0 \\ 0 & 1 & 0 & 0 \\ 0 & 0 & cos ( {ϕ}_{x} ) & sin ( {ϕ}_{x} ) \\ 0 & 0 & - sin ( {ϕ}_{x} ) & cos ( {ϕ}_{x} )\end{matrix} ] {S}_{in} ( k ) = \frac{1}{2} ( {S}_{0} + {S}_{1} cos ( {ϕ}_{y} ) - {S}_{3} cos ( {ϕ}_{x} ) sin ( {ϕ}_{y} ) + {S}_{2} sin ( {ϕ}_{x} ) sin ( {ϕ}_{y} ) ) \qquad Equation 4$$

In Equation 4 above, Iₒᵤₜ represents the amount of light for each wave number, each location x, and each location y, ϕₓ represents the phase delay about the x-axis, and ϕ_{y} represents the phase delay about the y-axis. Also, S₀(k)˜S₃(k) represents the spectrum of each polarization component, and is assumed to be constant for the x-axis and y-axis.

Here, it is assumed that, of the components constituting the self-interference structure 195 of the polarimeter 11, the first retarder 141 and the second retarder 143 are at 45 degrees and the polarizer 135 is at 0 degrees. Also, it is assumed that the plurality of retarders 160 cause a phase delay that changes in space in the x-direction with respect to the light.

Here, regarding light formed as an image on the image detection unit 150 of the polarimeter 11, the amount of light integrated with respect to the wave number is measured, and thus, the light amount may be expressed as in Equation 5 below.

$${I}_{out , measure} ( x , y ) = {\int }_{- ∞}^{∞} {I}_{out} ( k , x ) dk = \frac{1}{2} {\int }_{- ∞}^{∞} {S}_{0} ( k ) dk + \frac{1}{2} {\int }_{- ∞}^{∞} {S}_{1} ( k ) cos ( ky ) dk - \frac{1}{2} {\int }_{- ∞}^{∞} {S}_{3} ( k ) cos ( kx ) sin ( ky ) dk + \frac{1}{2} {\int }_{- ∞}^{∞} {S}_{2} ( k ) sin ( kx ) sin ( ky ) dk = \frac{1}{2} {\int }_{- ∞}^{∞} {S}_{0} ( k ) dk + \frac{1}{2} {\int }_{- ∞}^{∞} {S}_{1} ( k ) cos ( ky ) dk - \frac{1}{4} {\int }_{- ∞}^{∞} {S}_{3} ( k ) sin ( kx + ky ) dk + \frac{1}{4} {\int }_{- ∞}^{∞} {S}_{3} ( k ) sin ( kx - ky ) dk - \frac{1}{4} {\int }_{- ∞}^{∞} {S}_{2} ( k ) cos ( kx + ky ) dk + \frac{1}{4} {\int }_{- ∞}^{∞} {S}_{2} ( k ) cos ( kx - ky ) dk = \frac{1}{2} {\int }_{- ∞}^{∞} {S}_{0} ( k ) dk + \frac{1}{4} {\int }_{- ∞}^{∞} {S}_{1} ( k ) {e}^{jky} dk + \frac{1}{4} {\int }_{- ∞}^{∞} {S}_{1} ( k ) {e}^{- jky} dk - \frac{1}{8} {\int }_{- ∞}^{∞} ( {S}_{2} ( k ) + {jS}_{3} ( k ) ) {e}^{jk ( x + y )} dk - \frac{1}{8} {\int }_{- ∞}^{∞} ( {S}_{2} ( k ) - {jS}_{3} ( k ) ) {e}^{- jk ( x + y )} dk + \frac{1}{8} {\int }_{- ∞}^{∞} ( {S}_{2} ( k ) - {jS}_{3} ( k ) ) {e}^{jk ( x - y )} dk + \frac{1}{8} {\int }_{- ∞}^{∞} ( {S}_{2} ( k ) + {jS}_{3} ( k ) ) {e}^{- jk ( x - y )} dk$$

$$= \frac{1}{2} D {C}_{{S}_{0}} + \frac{1}{4} \{ {S}_{1} ( k ) \} + \frac{1}{4} {\{ {S}_{1} ( k ) \}}^{*} - \frac{1}{8} \{ {S}_{2} ( k ) + j {S}_{3} ( k ) \} - \frac{1}{8} {\{ {S}_{2} ( k ) + j {S}_{3} ( k ) \}}^{*} + \frac{1}{8} \{ {S}_{2} ( k ) - j {S}_{3} ( k ) \} + \frac{1}{8} {\{ {S}_{2} ( k ) - j {S}_{3} ( k ) \}}^{*}$$

Here, I_{out,measure}(x,y) represents the amount of light integrated with respect to the wave number, and Iₒᵤₜ(k, x) represents the amount of light per wave number k and location x.

As described above, through Equations 3 to 5, the amount of light I_{out,measure}(x,y) imaged by the self-interference structure 195 of the polarimeter 11 of the inventive concept and the spectrum of light S₀(k)˜S₃(k) are in a Fourier transform relationship. In addition, the polarization component of light incident on the self-interference structure 195 of the polarimeter 11 is separated into different frequencies, according to the phase delay amount (kx, ky) of the retarder. Thus, by performing Fourier transform on I_{out,measure} (x,y) with respect to the x component and the y component, respectively, the spectrum S₀(k) for each polarization component may be measured with respect to the wave number component.

As described above with reference to FIGS. 1 and 2, the image obtained from the polarimeter 11 in FIG. 3 may be converted into spectral data by the image detection unit 150 in FIG. 1, and this may be performed in the same manner as described in FIG. 1.

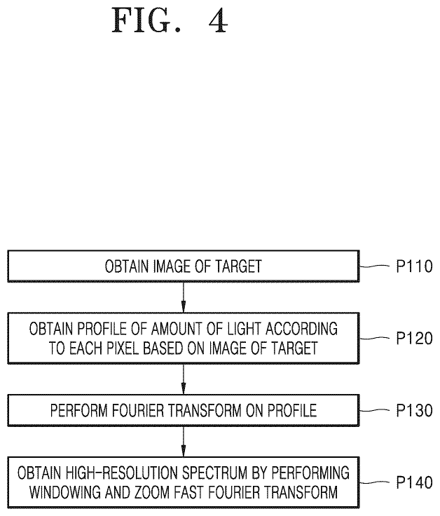

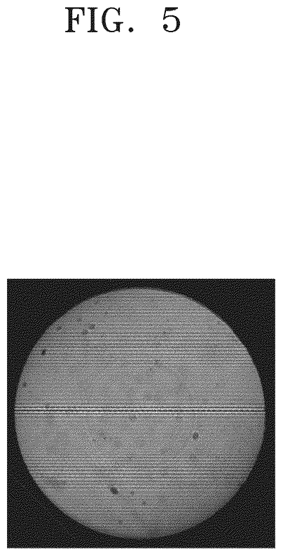

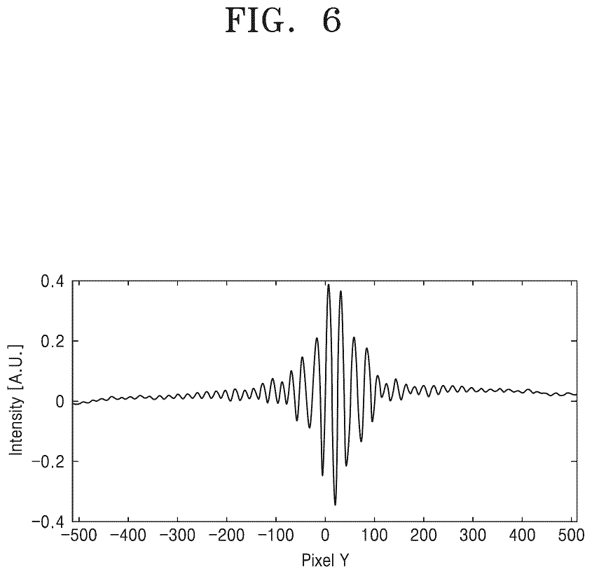

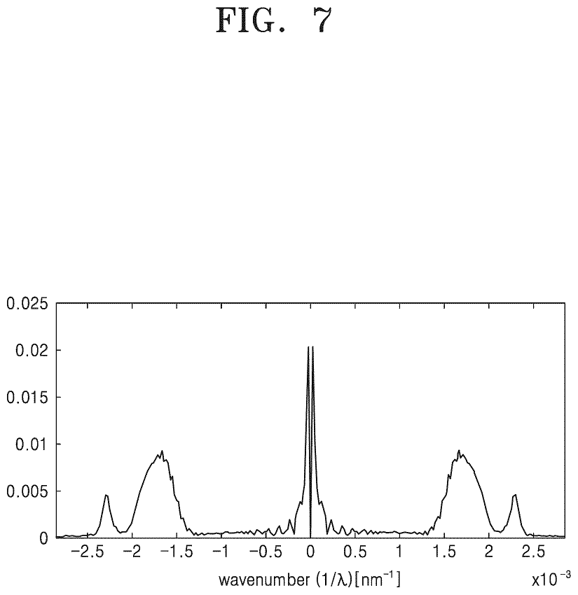

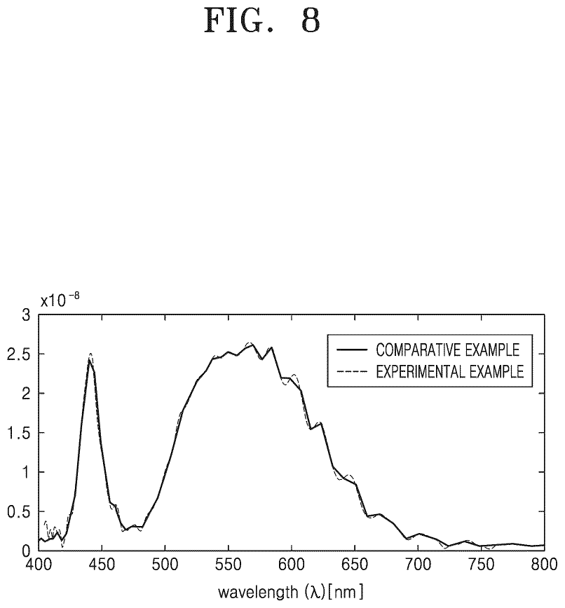

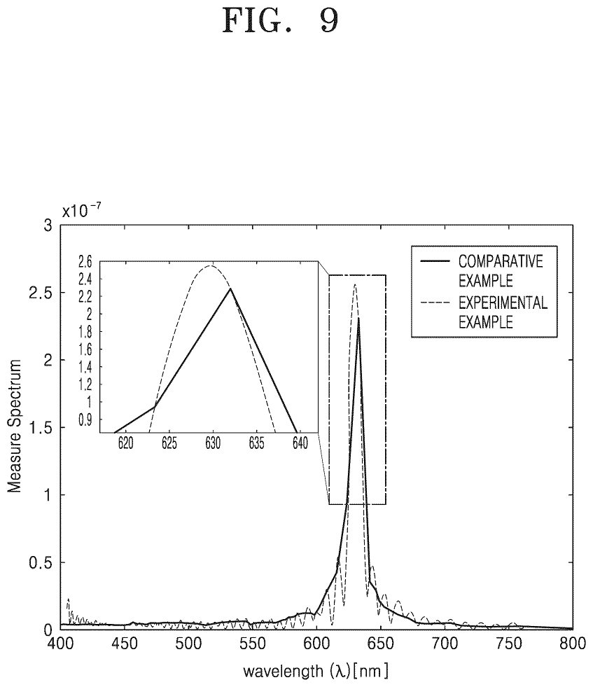

FIG. 4 is a flowchart of an image detection method according to an embodiment. FIG. 5 illustrates an image obtained by an image detector according to an embodiment. FIG. 6 is a graph showing a profile according to the amount of light for a plurality of pixels, according to an embodiment. FIG. 7 is a graph showing data obtained by performing Fourier transform on a profile, according to an embodiment. FIGS. 8 and 9 are graphs showing spectral data generated using Zoom fast Fourier Transform according to an embodiment. FIGS. 6 to 9 are diagrams showing an image measurement method with respect to the high-resolution spectrometer 10 of FIGS. 1 to 2.

Referring to FIGS. 4 and 5, in the image processing method according to the inventive concept, an image of a target may be obtained in operation P110. The image of the target may correspond to an image of the measurement object in FIG. 1 and may be obtained by an image detection unit of the image measurement device.

Referring to FIGS. 4 and 6, after obtaining the image of the target, a profile of the amount of light for each pixel may be obtained based on the image of the target in operation P120. In FIG. 6, the horizontal axis represents the positions of pixels in the Y-axis direction, and the vertical axis represents the amount of light. Here, the unit on the horizontal axis is pixel, and the unit on the vertical axis is arbitrary unit (AU). The profile may be generated by the image processing unit 200 of the image measurement devices described herein.

Referring to FIGS. 4 and 7, after obtaining the profile of the amount of light for each pixel, Fourier transform may be performed on the profile in operation P130. In FIG. 8, the horizontal axis represents the wave number, and the vertical axis represents the amount of light. The unit of the horizontal axis is nm⁻¹, and the unit of the vertical axis is an arbitrary unit. Through the Fourier transform, the profile may be separated into a high-frequency region and a low-frequency region based on wave number components of the profile of the amount of light for each pixel.

Referring to FIGS. 4 and 8, after performing the Fourier transform, windowing and zoom fast Fourier transform may be performed to obtain high-resolution spectral data. In FIG. 9, the horizontal axis represents the wavelength, and the vertical axis represents the amount of light. Here, the unit on the horizontal axis is nm, and the unit on the vertical axis represents an arbitrary unit. The experimental example on the graph represents high-resolution spectral data obtained through the image measurement method of the inventive concept, and the comparative example represents actual spectral data. As such, it may be confirmed that the experimental example obtained through the image measurement method is consistent with the comparative example.

FIG. 9 specifically shows spectral data obtained through the image measurement method of the inventive concept for a light source having a wavelength ranging from about 450 nm to about 650 nm. Here, the horizontal axis represents the wavelength, and the vertical axis represents the spectrum and light amount. The unit of the horizontal axis is nm, and the unit of the vertical axis is an arbitrary unit. When comparing the experimental example showing data values using the inventive concept, with the comparative example, which is an actual spectrum, it was found that the spectral data generally matched each other, and that measurement was possible even for a broadband light source. In addition, it was found that according to the image processing method according to the inventive concept, by performing windowing and zoom fast Fourier transform, resolution is significantly improved when generating spectral data by the image processing method of the inventive concept.

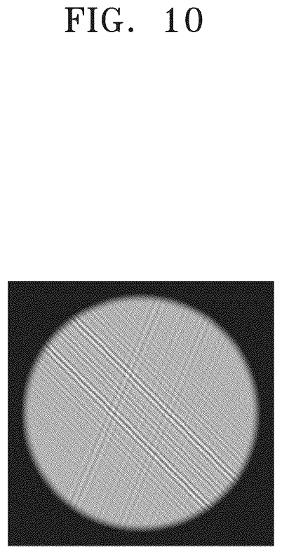

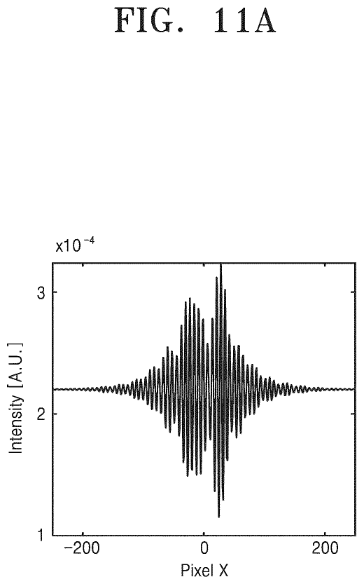

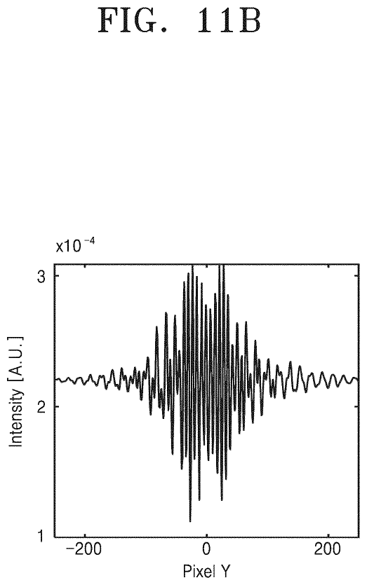

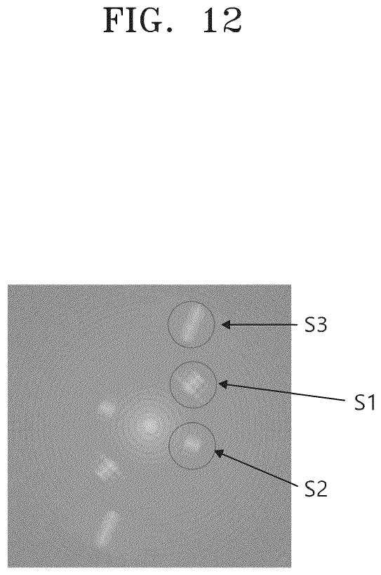

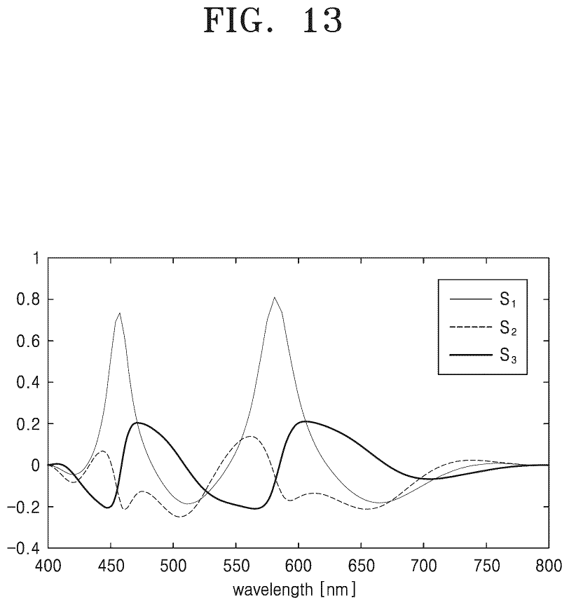

FIG. 10 illustrates an image obtained by an image detector, according to an embodiment. FIGS. 11A and 11B are graphs showing a profile according to the amount of light for a plurality of pixels, according to an embodiment. FIG. 12 is an image showing data obtained by performing Fourier transform on a profile, according to an embodiment. FIG. 13 is a graph showing spectral data generated using Zoom fast Fourier Transform, according to an embodiment. FIGS. 10 to 13 are diagrams showing an image measurement method for the polarimeter 11 of FIG. 3.

Referring to FIGS. 10, 11A, and 11B, an image of polarized light may be obtained by the image detection unit of the image measurement device. In FIG. 11A, the horizontal axis represents the position of the pixel on the x-axis, the vertical axis represents the amount of light, the unit on the horizontal axis is a pixel, and the unit on the vertical axis is an arbitrary unit. Additionally, in FIG. 11B, the horizontal axis represents the position of the pixel on the y-axis, the vertical axis represents the amount of light, and the units are the same as those in FIG. 11A. After obtaining an image of the target, a light amount profile for each pixel of the x-axis and each pixel of the y-axis may be obtained. Here, the polarimeter 11 of FIG. 3 does not include the light diffusion plate 110, and may measure images in a spectral state and a polarized state, due to a different structure from that of the high-resolution spectrometer 10 of FIGS. 1 and 2.

Referring to FIGS. 12 and 13, by performing Fourier transform on the profile, spectra S1 to S3 may be separated into a high-frequency region and a low-frequency region. In FIG. 13, the horizontal axis represents the wavelength, the vertical axis represents the amount of light, the unit of the horizontal axis is nm, and the unit of the vertical axis is an arbitrary unit. As such, the polarimeter 11 of FIG. 3 may generate the spectral data S1 to S3 according to a wave number for different polarization components.

As such, the image measurement device of some embodiments according to the inventive concept self-interferes light using a self-interference structure including a retarder and a polarizer, and performs Fourier transform, windowing, and zoom fast Fourier transform to obtain spectral data, thereby obtaining spectral data with improved resolution and accuracy.

While the inventive concept has been particularly shown and described with reference to embodiments thereof, it will be understood that various changes in form and details may be made therein without departing from the spirit and scope of the following claims. In this specification, embodiments have been described using specific terms, but this is only used for the purpose of explaining the technical idea of the inventive concept and is not used to limit the meaning or scope of the inventive concept described in the claims.

What is claimed is:

1. An image measurement device comprising:
an optical system that transmits light to an image detection unit;
the image detection unit configured to detect the light and generate an image; and
an image processing unit that extracts spectral data from the image,
wherein the image processing unit generates a profile according to an amount of light for each of a plurality of pixels based on the image.

2. The image measurement device of claim 1, wherein the optical system comprises:
a relay lens comprising at least one lens; and
a self-interference structure configured to self-interfere the light.

3. The image measurement device of claim 2, wherein the self-interference structure comprises a plurality of polarizers and a retarder, and
the plurality of polarizers comprises a first polarizer and a second polarizer, and
the second polarizer is disposed between the first polarizer and the image detection unit, and
the retarder is disposed between the first polarizer and the second polarizer.

4. The image measurement device of claim 3, wherein the second polarizer is disposed between the retarder and the image detection unit,
the first polarizer polarizes the light into S-polarized light and P-polarized light, and
the retarder delays respective phases of the S-polarized light and the P-polarized light.

5. The image measurement device of claim 2, wherein the self-interference structure comprises a polarizer and a plurality of retarders,
the polarizer is disposed between the plurality of retarders and the image detection unit, and
the plurality of retarders is in contact with each other.

6. The image measurement device of claim 5, wherein the plurality of retarders comprise a first retarder and a second retarder, and
a central axis of the first retarder is aligned with a central axis of the second retarder, and the first retarder is arranged in a first direction and the second retarder is arranged in a second direction different from the first direction.

7. The image measurement device of claim 1, wherein the self-interference structure polarizes the light, and self-interferes the light by delaying the phase of the light.

8. The image measurement device of claim 1, wherein the self-interference structure comprises a retarder, and
the retarder comprises any one of a Nomarski prism, a Wollaston prism, and a beam displacer.

9. The image measurement device of claim 1, wherein the image detection unit comprises any one of a complementary metal-oxide semiconductor (CMOS) and a charged coupled device (CCD).

10. The image measurement device of claim 1, wherein the image processing unit separates the profile into a high-frequency region and a low-frequency region by performing Fourier transform on the profile, and
divides the high-frequency region into a plurality of sections through windowing, and extracts frequency components by applying preset weights to the plurality of sections, and
extracts spectral data from the frequency components by using a zoom Fast Fourier transform.

11. An image measurement device comprising:
an optical system that transmits light to an image detection unit;
the image detection unit configured to detect the light and generate an image; and
an image processing unit that extracts spectral data from the image,
wherein the optical system comprises a relay lens including at least one lens and a self-interference structure configured to self-interfere the light, and
the self-interference structure comprises a polarizer that polarizes the light and a retarder that delays a phase of the light.

12. The image measurement device of claim 11, wherein the image processing unit generates a profile according to an amount of light for each of a plurality of pixels based on the image, and performs a Fourier transform on the profile.

13. The image measurement device of claim 11, wherein the polarizer comprises a first polarizer and a second polarizer,
the second polarizer is disposed between the first polarizer and the image detection unit,
the retarder is disposed between the first polarizer and the second polarizer,
the first polarizer polarizes the light into S-polarized light and P-polarized light, and
the retarder delays the phases of the S-polarized light and the P-polarized light, respectively,
the second polarizer passes the light, the phase of which is delayed by the retarder, and
the image detection unit detects self-interfered light passing through the second polarizer, as the image.

14. The image measurement device of claim 13, further comprising a light diffusion plate,
wherein the light diffusion plate diffuses the light and changes the light to an unpolarized state.

15. The image measurement device of claim 11, wherein the image processing unit separates the profile into a high-frequency region and a low-frequency region by performing Fourier transform on the profile,
divides the high-frequency region into a plurality of sections through windowing, and extracts frequency components by applying preset weights to the plurality of sections, and
extracts spectral data from the frequency components by using zoom Fast Fourier transform.

16. The image measurement device of claim 11, wherein the image detection unit comprises any one of a complementary metal-oxide semiconductor (CMOS) and a charged coupled device (CCD), and
the retarder comprises any one of a Nomarski prism, a Wollaston prism, and a beam displacer.

17. The image measurement device of claim 11, wherein the retarder comprises a first retarder and a second retarder, wherein the first retarder and the second retarder are in contact with each other,
a central axis of the first retarder is identical to a central axis of the second retarder, and the first retarder is arranged in a first direction and the second retarder is arranged in a second direction different from the first direction.

18. An image measurement device comprising:
an optical system that transmits light to an image detection unit;
the image detection unit configured to detect the light and generate an image; and
an image processing unit that extracts spectral data from the image,
wherein the optical system comprises a relay lens including at least one lens and a self-interference structure configured to self-interfere the light, and
the self-interference structure comprises a polarizer that polarizes the light and a retarder that delays the phase of the light, and
the image processing unit generates a profile according to an amount of light for each of a plurality of pixels based on the image and performs Fourier transform on the profile,
the image processing unit separates the profile into a high-frequency region and a low-frequency region by performing Fourier transform on the profile, and
divides the high-frequency region into a plurality of sections through windowing, and extracts frequency components by applying preset weights to the plurality of sections, and
extracts spectral data from the frequency components by using zoom Fast Fourier transform.

19. The image measurement device of claim 18, further comprising a light diffusion plate,
wherein the polarizer comprises a first polarizer and a second polarizer,
the first polarizer and the second polarizer are disposed between the light diffusion plate and the image detection unit,
the retarder is disposed between the first polarizer and the second polarizer,
the first polarizer polarizes the light into S-polarized light and P-polarized light,
the retarder delays the phases of the S-polarized light and the P-polarized light, respectively,
the second polarizer passes the phase-delayed light,
the image detection unit detects self-interfered light passing through the second polarizer, as the image,
the light diffusion plate diffuses the light and changes the light to an unpolarized state,
the self-interference structure self-interferences and splits the light, and
the image detection unit detects an image of the self-interfered and split light.

20. The image measurement device of claim 18, wherein the self-interference structure comprises a polarizer and a plurality of retarders,
the polarizer is disposed between the relay lens and the image detection unit,
the plurality of retarders is in contact with each other,
the plurality of retarders comprise a first retarder and a second retarder, and
a central axis of the first retarder is identical to a central axis of the second retarder, and the first retarder is arranged in a first direction and the second retarder is arranged in a second direction different from the first direction.
